(19) United States
(12) Patent Application Publication
(10) Pub. No.: US 2019/0144655 A1
(43) Pub. Date: May 16, 2019

(54) TIRE RUBBER COMPOSITION AND PNEUMATIC TIRE

(71) Applicant: TOYO TIRE & RUBBER CO., LTD., Itami-shi (JP)

(72) Inventor: Shuhei Koyama, Itami-shi (JP)

(73) Assignee: TOYO TIRE & RUBBER CO., LTD., Itami-shi (JP)

(21) Appl. No.: 16/169,470

(22) Filed: Oct. 24, 2018

(30) Foreign Application Priority Data
Nov. 13, 2017 (JP) 2017-218335

(51) Int. Cl. C08L 23/22; C08L 83/04; C08L 95/00; C08K 3/04; B60C 1/00

(52) U.S. Cl. CPC C08L 23/22; C08L 83/04; B60C 1/0008; C08K 3/04; C08L 95/00

(57) ABSTRACT

A tire rubber composition comprises butyl-type rubber and silicone oil. The silicone oil comprises silicone having at least two mercapto groups. The tire rubber composition may be used as an innerliner rubber composition.

### TECHNICAL FIELD

The present disclosure relates to a tire rubber composition and a pneumatic tire.

### BACKGROUND ART

It is desired of innerliners that they impede passage of air therethrough, which is to say that they have superior impermeability with respect to air. This is because the role of the innerliner in a pneumatic tire is to maintain the air pressure of the tire.

It is desired of innerliners that they have high strength with respect to repetitive flexural deformation, which is to say that they have superior fatigue resistance. This is because innerliners experience repetitive flexural deformations as a result of the rolling of the pneumatic tire.

### PRIOR ART REFERENCES

### Patent References

PATENT REFERENCE NO. 1: Japanese Patent Application Publication Kokai No. 2014-118419

### SUMMARY OF INVENTION

### Problem to be Solved by Invention

While innerliner fatigue resistance can be improved by causing oil in common use for innerliners to be added to the rubber, this tends to cause decrease in impermeability with respect to air.

It is an object of the present disclosure to provide a tire rubber composition permitting improvement in both fatigue resistance and impermeability with respect to air. It is another object of the present disclosure to provide a pneumatic tire.

### Means for Solving Problem

A tire rubber composition in accordance with the present disclosure comprises a butyl-type rubber and silicone oil, the silicone oil comprising silicone having at least two mercapto groups. A pneumatic tire in accordance with the present disclosure is equipped with an innerliner fabricated using the tire rubber composition.

### EMBODIMENTS FOR CARRYING OUT INVENTION

A tire rubber composition in an embodiment in accordance with the present disclosure comprises a butyl-type rubber and silicone oil, the silicone oil comprising silicone having at least two mercapto groups.

A tire rubber composition in an embodiment in accordance with the present disclosure may improve fatigue resistance. This is thought to be due to the fact that formation of a structure having superior flexibility is permitted as a result of it having been made possible for there to be a reaction between the double bonds of the butyl-type rubber and the mercapto group(s) in the silicone within the silicone oil.

A tire rubber composition in an embodiment in accordance with the present disclosure may improve impermeability with respect to air. This is thought to be due to the fact that suppression of leakage of air is permitted as a result of it having been made possible for the silicone to constrain the butyl-type rubber.

It is preferred that the silicone have mercapto group(s) at least at either end thereof. This will make it possible to further improve fatigue resistance and impermeability with respect to air.

A first embodiment in accordance with the present disclosure is described below.

A tire rubber composition in accordance with the first embodiment comprises butyl-type rubber. As butyl-type rubber, halogenated butyl rubber and butyl rubber (HR) may be cited as examples. As halogenated butyl rubber, brominated butyl rubber (BIER) and chlorinated butyl rubber (CDR) may be cited as examples. Any one of these may be used, or any two or more of these may be used. A tire rubber composition in accordance with the first embodiment may further comprise rubber(s) other than butyl-type rubber. As such rubber(s), natural rubber, isoprene rubber, butadiene rubber, styrene-butadiene rubber, styrene-isoprene copolymer rubber, butadiene-isoprene copolymer rubber, styrene-isoprene-butadiene copolymer rubber, and so forth may be cited as examples. It is preferred that the amount of butyl-type rubber be not less than 80 mass %, more preferred that this be not less than 90 mass %, and still more preferred that this be 100 mass %, per 100 mass % of rubber (total rubber; i.e., combined total of butyl-type rubber and rubber(s) other than butyl-type rubber) within the rubber composition.

A tire rubber composition in accordance with the first embodiment comprises silicone oil. Viscosity at 25° C. of the silicone oil might, for example, be not greater than 500 mm²/s. The lower limit of the range in values for the viscosity at 25° C. might, for example, be 20 mm²/s, 40 mm²/s, or the like. For every 100 parts by mass of rubber within the rubber composition, it is preferred that the amount of silicone oil be not less than 0.5 part by mass, more preferred that this be not less than 1 part by mass, and still more preferred that this be not less than 2 parts by mass. On the other hand, for every 100 parts by mass of rubber, the upper limit of the range in values for the amount of silicone oil might, for example, be 20 parts by mass, 15 parts by mass, 10 parts by mass, or the like.

The silicone oil comprises silicone having at least two mercapto groups. It is preferred that the silicone have a dimethylpolysiloxane structure. This is because dimethylpolysiloxane structures have excellent flexibility. More specifically, it is preferred that the silicone have a dimethylpolysiloxane structure at the main chain. At the dimethylpolysiloxane structure, group(s) having mercapto group(s) may be substituted for one or a plurality of methyl group(s). Thus, while the silicone may be such that mercapto group(s) are present in side chain(s), it is preferred that mercapto group(s) be present at either end thereof. In such case, it is preferred that the silicone possess two mercapto groups within the molecule.

A tire rubber composition in accordance with the first embodiment may comprise pulverized bituminous coal in which bituminous coal has been crushed into fine pieces. Pulverized bituminous coal may improve impermeability with respect to air. Average particle diameter of the pulverized bituminous coal might, for example, be not less than 0.5 μm, or not less than 1 μm. The upper limit of the range in values for the average particle diameter of the pulverized bituminous coal might, for example, be 100 μm, 30 μm, or the like. Average particle diameter may be measured using the laser diffraction/scattering method. Aspect ratio of the pulverized bituminous coal might, for example, be 5 to 30. Aspect ratio is the ratio of length of the major axis (maximum dimension at flat portion) to thickness. Aspect ratio may be determined by transmission electron microscopy (TEM). More specifically, major axis length and thickness are measured for 10 particles selected at random from TEM micrograph(s), and the aspect ratios of the respective particles are calculated. What is referred to as the aspect ratio of pulverized bituminous coal is the arithmetic mean of these aspect ratios. It is preferred that the amount of pulverized bituminous coal be not less than 5 parts by mass for every 100 parts by mass of rubber within the rubber composition. On the other hand, for every 100 parts by mass of rubber, the upper limit of the range in values for the amount of pulverized bituminous coal might, for example, be 50 parts by mass, 40 parts by mass, 30 parts by mass, or the like.

A tire rubber composition in accordance with the first embodiment may comprise carbon black as filler. Iodine absorption (IA) of the carbon black might, for example, be 15 mg/g to 55 mg/g. IA is the value thereof as measured in accordance with JIS K 6217-1. Dibutyl phthalate oil absorption (DBP) of the carbon black might, for example, be 75 cm³/100 g to 125 cm³/100 g. DBP oil absorption is the value thereof as measured in accordance with JIS K 6217-4. More specifically, GPF-grade carbon black is preferred. For every 100 parts by mass of rubber within the rubber composition, it is preferred that the amount of carbon black be not less than 30 parts by mass, and more preferred that this be not less than 40 parts by mass. On the other hand, for every 100 parts by mass of rubber, the upper limit of the range in values for the amount of carbon black might, for example, be 70 parts by mass, 60 parts by mass, or the like. It is also possible for a tire rubber composition in accordance with the first embodiment to comprise clay, talc, or the like as filler.

For every 100 parts by mass of rubber within the rubber composition, it is preferred that the combined amount of carbon black and pulverized bituminous coal be not less than 40 parts by mass, and more preferred that this be not less than 50 parts by mass. On the other hand, for every 100 parts by mass of rubber, the upper limit of the range in values for the combined amount thereof might, for example, be 120 parts by mass, 110 parts by mass, 100 parts by mass, or the like.

A tire rubber composition in accordance with the first embodiment may comprise tackifier. It is preferred that the tackifier be hydrocarbon resin(s). As hydrocarbon resin, aliphatic petroleum resins, aromatic petroleum resins, aliphatic/aromatic copolymeric petroleum resins, and the like may be cited as examples. For every 100 parts by mass of rubber within the rubber composition, it is preferred that the amount of tackifier be not less than 1 part by mass, and more preferred that this be not less than 2 parts by mass. On the other hand, for every 100 parts by mass of rubber, the upper limit of the range in values for the amount of tackifier might, for example, be 15 parts by mass, 10 parts by mass, 5 parts by mass, or the like.

A tire rubber composition in accordance with the first embodiment may comprise zinc oxide. For every 100 parts by mass of rubber within the rubber composition, it is preferred that the amount of zinc oxide be not less than 1 part by mass, and more preferred that this be not less than 2 parts by mass. On the other hand, for every 100 parts by mass of rubber, the upper limit of the range in values for the amount of zinc oxide might, for example, be 5 parts by mass, 4 parts by mass, or the like.

A tire rubber composition in accordance with the first embodiment may further comprise stearic acid, antioxidant, sulfur, vulcanization accelerator, and/or the like.

A tire rubber composition in accordance with the first embodiment is capable of being used to fabricate tire member(s) making up a tire, and in particular may be favorably used to fabricate an innerliner.

A pneumatic tire in accordance with the first embodiment is equipped with an innerliner fabricated using a tire rubber composition. More specifically, a pneumatic tire in accordance with the fust embodiment is equipped with an innerliner comprising a tire rubber composition. The innerliner may be disposed at a location toward the interior from a carcass layer.

### WORKING EXAMPLES

Working examples in accordance with the present disclosure are described below.

Raw materials and reagents are indicated below.

| | |
|---|---|
| Brominated | “Bromobutyl 2222” manufactured by Exxon |
| butyl rubber | Mobil Chemical Company |
| Carbon black | “SEAST V” manufactured by Tokai Carbon Co., |
| | Ltd. (GPF; IA 26 mg/g; DBP oil absorption 87 cm³/ |
| | 100 g) |
| Pulverized | “Austin Black 325” manufactured by Coal |
| bituminous | Fillers, Inc. |
| coal | |
| Tackifier | “Escorez 1102” manufactured by Exxon Mobil |
| | Chemical Company |
| Oil | “NC-140” manufactured by J X Nippon Oil and |
| | Energy Corporation |
| Silicone Oil A | “KF-2001” manufactured by Shin-Etsu Silicones |
| | (silicone oil comprising silicone having |
| | mercapto group(s) in side chain(s); viscosity 200 mm²/s |
| | at 25° C.) |
| Silicone Oil B | “X-22-167B” manufactured by Shin-Etsu |
| | Silicones (silicone oil comprising silicone |
| | having mercapto groups at either end; viscosity |
| | 55 mm²/s at 25° C.) |
| Zinc oxide | “Zinc Oxide No. 3” manufactured by Mitsui |
| | Mining & Smelting Co., Ltd. |
| Stearic acid | “LUNAC S-20” manufactured by Kao |
| | Corporation |
| Vulcanization | “NOCCELER DM-P” manufactured by Ouchi |
| accelerator | Shinko Chemical Industrial Co., Ltd. |
| Sulfur | “5% Oil Treated Sulfur Powder” manufactured |
| | by Tsurumi Chemical Industry Co., Ltd. |

### Fabrication of Unvulcanized Rubber

The compounding ingredients except for sulfur and vulcanization accelerator were added to rubber in accordance with TABLE 1, a Model B Banbury mixer manufactured by Kobe Steel, Ltd., was used to carry out kneading, and the rubber mixture was discharged. The rubber mixture was then kneaded together with sulfur and vulcanization accelerator in a Model B Banbury mixer to obtain unvulcanized rubber.

Impermeability with respect to Air

The unvulcanized rubber was vulcanized at 160° C. for 30 min, and this was fabricated into vulcanized rubber sheeting of thickness 1 mm. A gas permeability test device (“BT-3” manufactured by Toyo Seiki) was used to measure the permeability with respect to air of the vulcanised rubber sheeting, values for each example being shown as indexed relative to a value of 100 for the value at Comparative Example 1. The higher the index the less tendency for air to pass therethrough and the more excellent the impermeability with respect to air.

### Fatigue Resistance

The unvulcanized rubber was vulcanized at 160° C. for 30 min, and this was fabricated into test pieces. Number of repetitions for crack growth of the test pieces was measured using a De Mattia flex test device in accordance with JIS K 6260. Values for the respective examples are shown indexed relative to a value of 100 for that of Comparative Example 1. The higher the index the more excellent the fatigue resistance.

TABLE 1

| | | Comparative | Comparative | Working | Working | Working |
|---|---|---|---|---|---|---|
| | | Example 1 | Example 2 | Example 1 | Example 2 | Example 3 |
| Parts | Brominated butyl rubber | 100 | 100 | 100 | 100 | 100 |
| by | Carbon black | 50 | 50 | 50 | 50 | 50 |
| mass | Pulverized bituminous coal | 10 | 10 | 10 | 10 | 10 |
| | Tackifier | 3 | 3 | 3 | 3 | 3 |
| | Oil | 5 | 20 | — | — | — |
| | Silicone Oil A | — | — | 5 | — | — |
| | Silicone Oil B | — | — | — | 1 | 5 |
| | Zinc oxide | 3 | 3 | 3 | 3 | 3 |
| | Stearic acid | 1 | 1 | 1 | 1 | 1 |
| | Vulcanization accelerator | 2 | 2 | 2 | 2 | 2 |
| | Sulfur | 0.5 | 0.5 | 0.5 | 0.5 | 0.5 |

| | | | | | |
|---|---|---|---|---|---|
| Impermeability with respect to air | 100 | 61 | 108 | 137 | 111 |
| Fatigue resistance | 100 | 119 | 125 | 101 | 131 |

Addition of silicone oil to rubber instead of oil (NC-140) permitted improvement in both impermeability with respect to air as well as fatigue resistance of the vulcanised rubber. For example, addition of Silicone Oil A to rubber instead of oil (NC-140) improved impermeability with respect to air by 8 points and improved fatigue resistance by 25 points (see Comparative Example 1 and Working Example 1). On the other hand, addition of Silicone Oil B to rubber improved impermeability with respect to air by 11 points and improved fatigue resistance by 31 points (see Comparative Example 1 and Working Example 3).

1. A tire rubber composition comprising:
butyl-type rubber; and
silicone oil;
wherein the silicone oil comprises silicone having at least two mercapto groups.

2. The tire rubber composition according to claim 1 wherein the silicone has mercapto groups at least at either end thereof.

3. The tire rubber composition according to claim 1 wherein the silicone has a dimethylpolysiloxane structure.

4. The tire rubber composition according to claim 1 further comprising pulverized bituminous coal.

5. The tire rubber composition according to claim 1 further comprising carbon black.

6. The tire rubber composition according to claim 1 further comprising tackifier.

7. The tire rubber composition according to claim 1 further comprising sulfur.

8. The tire rubber composition according to claim 1 wherein the silicone oil is present in an amount that is 0.5 part by mass to 20 parts by mass per 100 parts by mass of rubber inclusive of the butyl-type rubber.

9. The tire rubber composition according to claim 8 wherein the butyl-type rubber is present in an amount that is not less than 80 mass % per 100 mass % of the rubber.

10. The tire rubber composition according to claim 8 wherein the butyl-type rubber is present in an amount that is not less than 90 mass % per 100 mass % of the rubber.

11. The tire rubber composition according to claim 8 wherein the rubber is made up of only the butyl-type rubber.

12. The tire rubber composition according to claim 1 which is capable of being used as an innerliner rubber composition.

13. A pneumatic tire provided with an innerliner fabricated using the tire rubber composition according to claim 1.
